(19) United States
(12) Patent Application Publication
(10) Pub. No.: US 2013/0173307 A1
(43) Pub. Date: Jul. 4, 2013

(54) INTERFACE FOR AN ELECTRONIC MEDICAL RECORD SYSTEM

(71) Applicant: Roche Diagnostics Operations, Inc., Indianapolis, IN (US)

(72) Inventors: Igor Gejdos, Indianapolis, IN (US); Paul J. Galley, Cumberland, IN (US)

(73) Assignee: ROCHE DIAGNOSTICS OPERATIONS, INC., Indianapolis, IN (US)

(21) Appl. No.: 13/728,341

(22) Filed: Dec. 27, 2012

Related U.S. Application Data
(60) Provisional application No. 61/581,158, filed on Dec. 29, 2011.

(51) Int. Cl. G06F 19/00

(52) U.S. Cl. CPC G06F 19/324
USPC 705/3

(57) ABSTRACT

An interface for an electronic medical record (EMR) system is configured to receive messages and documents having a message data format and a document data format respectively, transmitted to EMR system in accordance with a first and second device healthcare interoperability standard. The interface is further configured to determine whether a given message or document pertains to blood glucose measures and to generate records in a custom format of the EMR system. The interface is further configured to parse the messages and documents for a structure collection procedure from a comment field in the given messages and documents and to map the structured collection procedure data to applicable data fields in a corresponding record of the EM system.

### CROSS-REFERENCE TO RELATED APPLICATIONS

This application claims the benefit of U.S. Provisional Application No. 61/581,158, filed on Dec. 29, 2011. The entire disclosure of the above application is incorporated herein by reference.

### FIELD

The present disclosure relates to an interface for an electronic medical record system.

### BACKGROUND

Physicians and other health care professionals (HCPs) often store patient medical information electronically in the form of an electronic medical record (EMR). An EMR can include a variety of different types of patient medical information, such as a patient's prior medical conditions, current medical condition, patient observations made by a physician, laboratory test results, and the results of tests performed by the patient himself, such as data from the patient's blood glucose monitor. EMR management systems are useful for centralizing storage of, and providing common access to, a patient's EMR(s).

For example, a patient's EMR and various types of patient medical information can be uploaded into an EMR management system by a doctor or other health care professional (HCP), by a medical testing laboratory, and by the patient himself. An HCP, patient, or other authorized person can then access the patient's EMR in real time using the EMR management system. Due to various different communication standards, it can often be difficult for an HCP, a patient, and a medical laboratory to communicate with an EMR management system. It would therefore be advantageous to have an EMR management system that is capable of communicating with a wide variety of third party systems regardless of the communication standards used.

This section provides background information related to the present disclosure which is not necessarily prior art.

### SUMMARY

An interface is provided for an electronic medical record (EMR) system. The interface is comprised generally to one or more message interface modules, a message extraction module, one or more document interface modules and a document extraction module. A first message interface module is configured to receive messages having a message data format and transmitted to the EMR system in accordance with a first device healthcare interoperability standard. For each message, the first message interface module determines whether a given message pertains to blood glucose measures and generates records in a custom format of the EMR system. Similarly, a second message interface module is configured to receive messages having the message data format and transmitted to the EMR system in accordance with a second device healthcare interoperability standard. For each message, the second message interface module determines whether a given message pertains to blood glucose measures and generates records in the custom format of the EMR system. The message extraction module is interoperable with the first and second message interface module to parse the received messages. More specifically, the message extraction module extracts data for a structured collection procedure from a comment field of the given message and maps the structured collection procedure data to applicable data fields in a corresponding record of the EMR system.

In a similar manner, a first document interface module is configured to receive documents having a document data format and transmitted to the EMR system in accordance with the first device healthcare interoperability standard. The first document interface module determines whether a given document pertains to blood glucose measures and generates records in the custom format of the EMR system. The second document interface module is configured to receive documents having the document data format and transmitted to the EMR system in accordance with the second device healthcare interoperability standard. The second document interface module determines whether a given document pertains to blood glucose measures and generates records in the custom format of the EMR system. The document extraction module is interoperable with the first and second document interface module to parse the received documents. The document extraction module extracts data for a structure collection procedure from a comment field of the given document and maps the structured collection procedure data to applicable data fields in a corresponding record of the EMR system.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 illustrates interaction between a plurality of systems and an electronic medical record central management (EMS CM) system including an interface according to the principles of the present disclosure;

FIG. 2 illustrates communication between the EMS CM and various interfaces to perform synchronization with a diabetes management system (DMS);

FIG. 3 includes a summary of interfaces included with the interface of FIG. 1;

FIG. 4 illustrates a functional block diagram of the interface;

FIGS. 5A and 5B includes example reports of structured testing data retrieved from the EMS CM of FIG. 1; and

FIG. 6 is a flow diagram illustrating structure test data extraction method according to the present disclosure.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

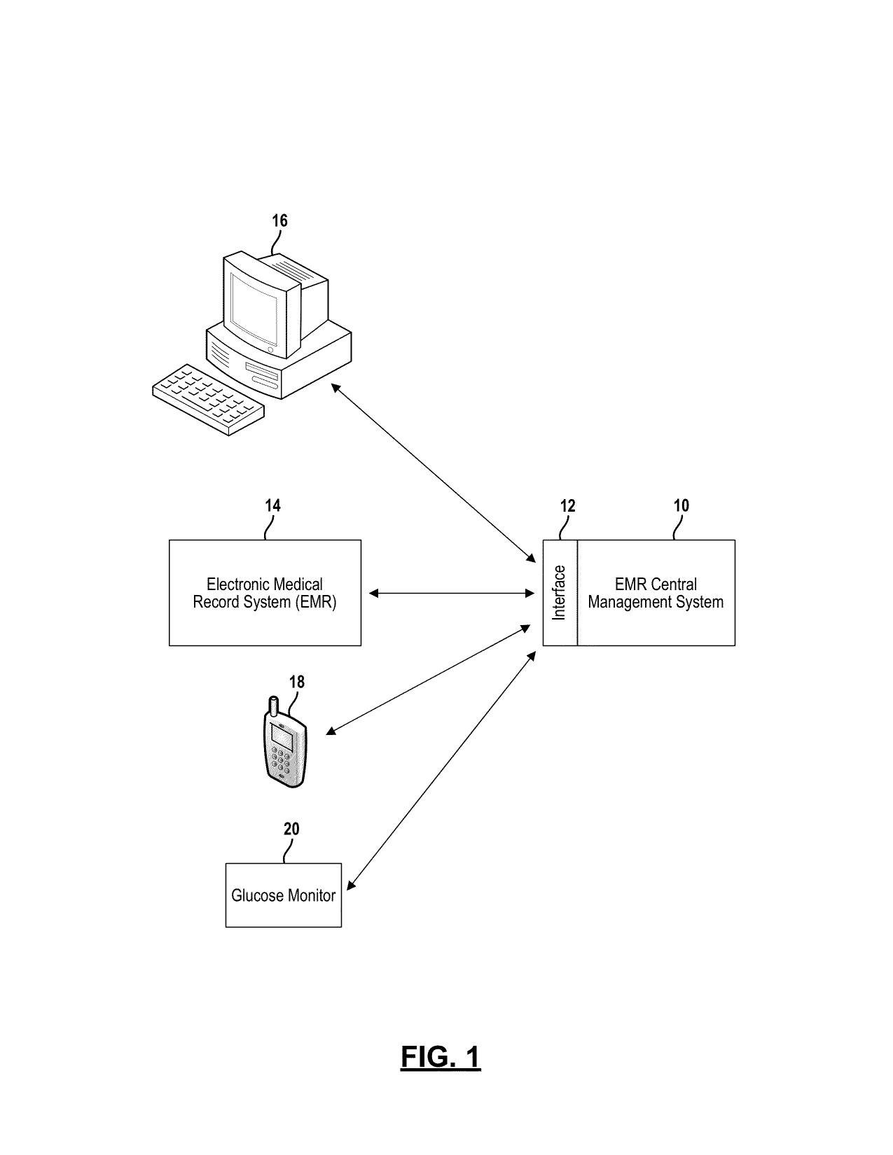

With initial reference to FIG. 1, an electronic medical record central management (EMR CM) system according to the present teachings is illustrated at reference numeral 10. The EMR CM system 10 includes an interface 12. The interface 12 and the EMR CM system 10 may be integral or connected in any suitable manner, such as through the Internet or any other suitable networked or non-networked connection. The interface 12 and the EMR CM system 10 may be at the same location or be remote to each other. The interface 12 is configured to facilitate communication between the EMR CM system 10 and a plurality of data communications systems. The plurality of data communications systems includes, but is not limited to; an electronic medical record (EMR) system 14, a personal computer (PC) 16, a smartphone 18, and a glucose monitor 20. Each of the plurality of data communications systems may be operated by a third party to the EMR CM system 10. For example, a health care provider may communicate patient medical data to the interface 12. The health care provider may input the data into the smartphone 18, the PC 16, or the EMR 14. In another example, a patient may operate a glucose monitor, such as the glucose monitor 20. The glucose monitor 20 may periodically communicate data gathered from the patient to the interface 12.

The EMR system 14 can include one or more facilities, having one or more patients. The facilities share data with the EMR CM system 10 in the context of an account. For example, a diabetes management system (DMS) facility may be included in the EMR system 14 and the DMS facility can include a plurality of DMS patients. Data for a DMS patient can be uploaded to the EMR CM system 10 by synchronization with a common data format document, for example. The interface 12 makes such synchronization possible. Each DMS patient will have their own unique patient ID. A DMS patient can be considered an index patient when their EMR is present in an account of the EMR CM system 10. A DMS patient is also typically a facility patient because his or her EMR can also be present in the EMR system 14. An electronic medical record (EMR) can also be referred to as a computer-based patient record (CPR) or electronic health record (EHR).

For the EMR CM system 10 to communicate and sync with each of the plurality of data communications systems, the plurality of data communications systems must be authenticated. For example, the EMR system 14 is authenticated with a dedicated user of the EMR system 14. The user can work in the context of one account maintained on the EMR CM System 10. Thus, for each account that the EMR system 14 sends data to or queries data from, it has to authenticate with a dedicated user. This user can only be used for performing requests against the EMR interface 12.

Authentication of the EMR system 14 can be performed in any suitable manner, such as with web services security (WS) using simple object access protocol (SOAP) based request/response interactions. The EMR CM system 10 can be configured to operate with a standard username token profile. The remote EMR system 14 can authenticate with username/password, which are parameters of the username token based on the username of the remote EMR system 14 user. Both the username and the password can be generated by the EMR CM system 10 and are exchanged with the remote EMR system 14.

When the remote EMR system 14 is paired with an account of the EMR CM system 10, shared username and password information is exchanged. The shared password must be input into the remote EMR system 14 for further authentication. The account can be derived from the shared password. A remote EMR system 14 can only access data belonging to the same account.

The EMR system 14 must also be identified by the EMR CM system 10 for a variety of reasons, such as to track logging and auditing, and to resolve EMR context. For example, data uploaded from the EMR system 14 is persisted in the context of the EMR. If a user of the EMR system 14 with an office account in the EMR CM system 10, such as a caregiver, runs several EMR instances, each of them must be uniquely identified. The data is exchanged with a pairing mechanism, and can be retrieved by the EMR CM system 10 for all future requests issued by the EMR system 14.

If the specific standard requires transferring data for identifying the EMR system 14, such as the ID, the identification data is transferred and compared to data exchanged during pairing. Any mismatch results in generation of an error. If the specific standard makes transferring data for identifying the EMR system 14 optional, the data should also be transferred and compared to data exchanged during pairing. Any data mismatch results in generation of an error. If the specific standard does not permit transferring identification data in a standard way, then no data should be transferred. Data exchanged during pairing is thus used for logging and auditing.

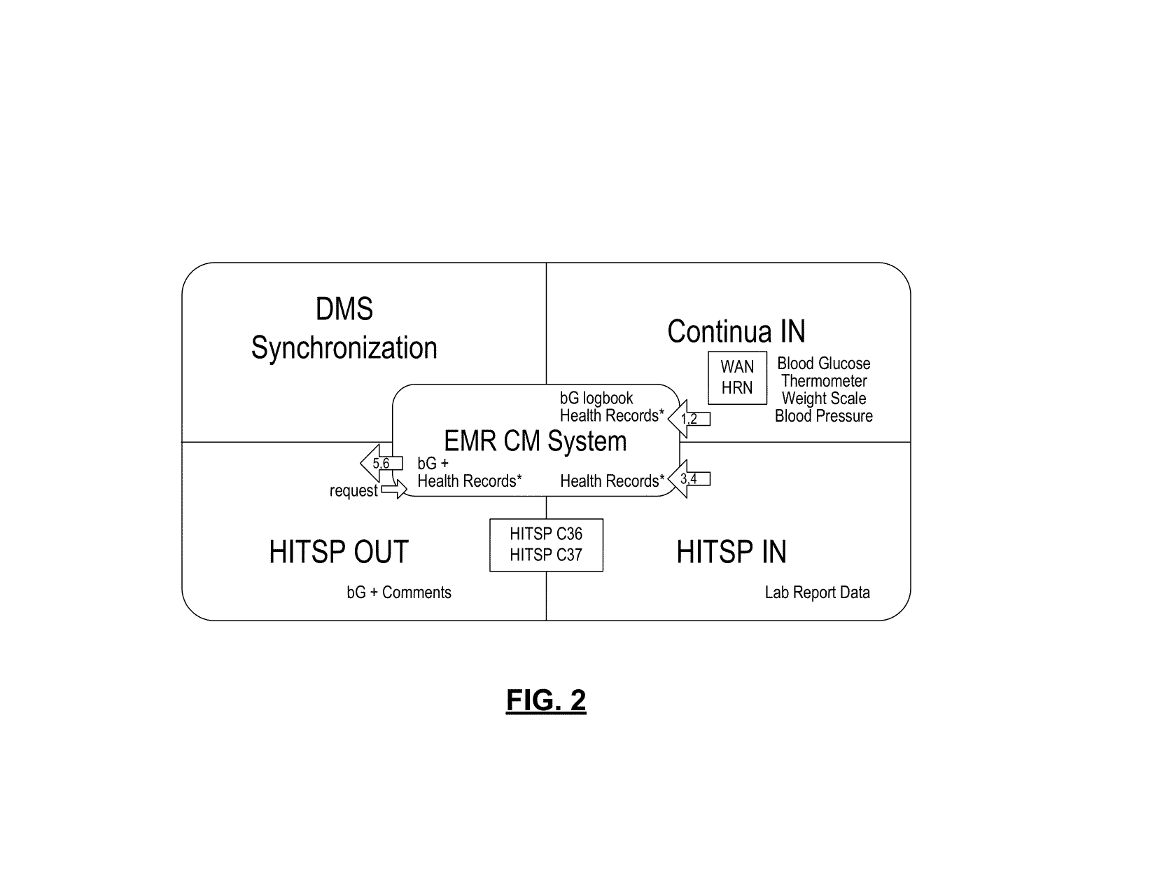

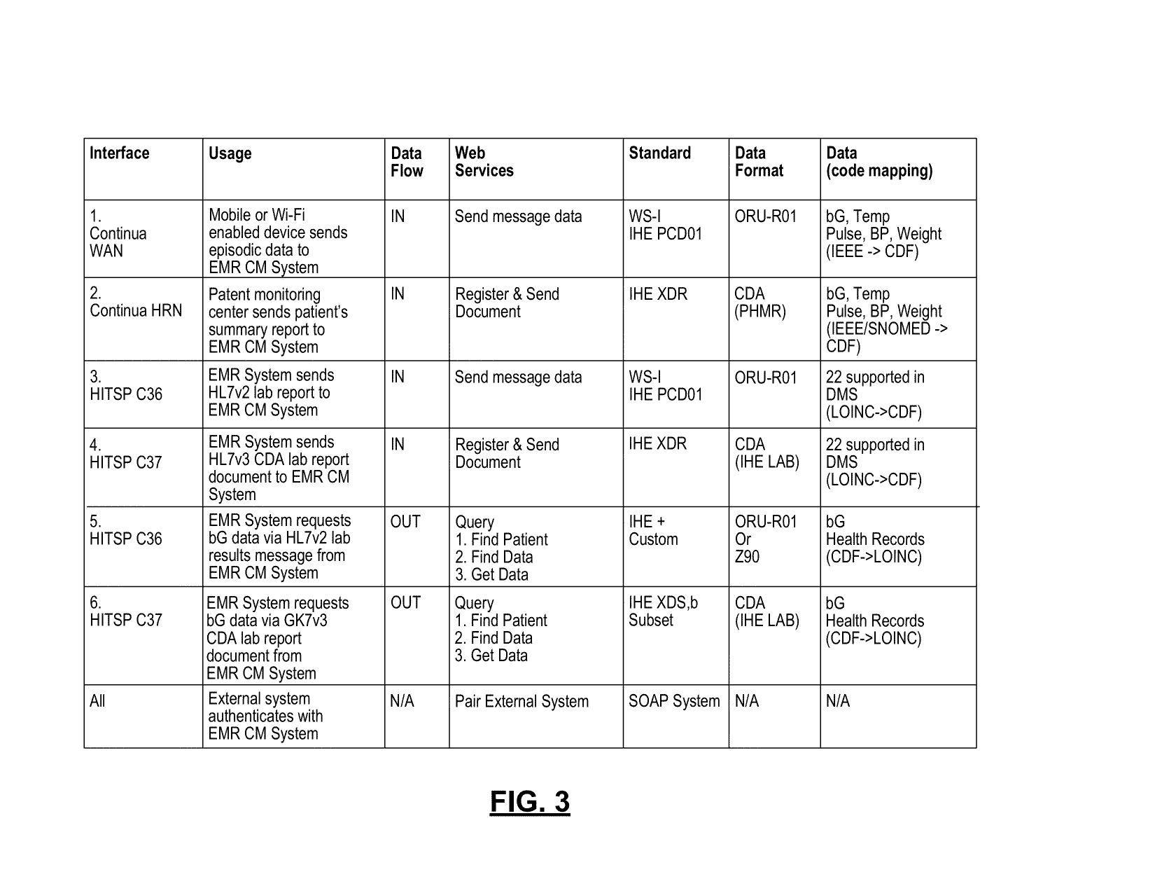

With particular reference to FIGS. 2 and 3, the interface 12 generally includes inbound interfaces and outbound interfaces. The inbound interfaces are configured to upload data (such as patient data, medical data, etc.) from the EMR system 14 to the EMR CM system 10. The EMR system 14 initiates communication with the EMR CM system 10. The inbound interfaces provide push/put/create/update like functionality. The outbound interfaces are configured to download data (such as patient data, medical data, etc.) from the EMR CM system 10 to the EMR system 14. It is thus the EMR system 14 that initiates communication with the EMR CM system 10. The outbound interfaces provides pull/get/read like functionality.

Patient demographic data is transmitted to the inbound interfaces for data to be uploaded. A suitable standard including suitable identification elements can be used, such as the following: First Name, Last Name, Date of Birth, Gender, and Middle Name (if known). Once the patient demographic data is uploaded, the patient is mapped. For example, a user of the EMR CM system 10 can manually map a patient originating from one source to a patient originating from another source. Patients need only be mapped to create a new patient record, not for validation or updates of already existing demographic data. This simplifies the interface 12 and eliminates any need for the EMR system 14 to differentiate between a first time patient upload and subsequent uploads. FIG. 2 also generally illustrates the mapping.

To upload data for a plurality of patients, the EMR system 14 issues an upload request for each patient and uploads are performed individually for each patient. Similarly, to download data for a plurality of patients, a request includes identification data for one patient and the response from the EMR CM system 10 will include data for one patient. The EMR system 14 issues a query request for each patient for which data is to be downloaded.

The EMR system 14 is paired with each account of the EMR CM system 10 that the EMR system 14 is to be used with. Using the pairing mechanism, the EMR system 14 retrieves a username/password combination. Thus, for each account the EMR system 14 has dedicated username/password credentials, and both stores and manages this information, as well as the mapping between the account and the associated username/password. The account that the EMR system 14 is to be paired with is identified by authentication. An account user is used for authentication of the pairing request. Metadata is transferred with the pairing request. The unique ID of the EMR system 14 is part of the metadata. In this manner, the EMR system 14 that an account is to be paired with is identified. The metadata also includes the human readable name of the EMR system 14. The response includes a generated username and password. Only the account owner can be permitted to execute the pairing requests. After pairing is successfully completed, a new EMR system user can be created in the system. If the account that the EMR system 14 is paired with is closed or deactivated, the EMR system user can be deactivated as well. The EMR system 14 cannot login anymore with the generated username and password and any request will fail with authentication related errors.

To identify the patient, the EMR system 14 uses the EMR patient ID, such as the ID provided by the EMR system 14 itself. The EMR system 14 cannot upload data using the ID of an index patient even if that patient is mapped to an EMR patient. Both the metadata and the payload document contain the patient identifiers. The assigning authority should match the ID of the EMR system 14, and the ID should be unique for assigning authority.

When the EMR system 14 sends a document for a particular patient for the first time, a new facility patient related to this EMR system 14 is allocated. Demographic data can be provided both in the metadata and the payload document, the contents of both should be consistent with each other.

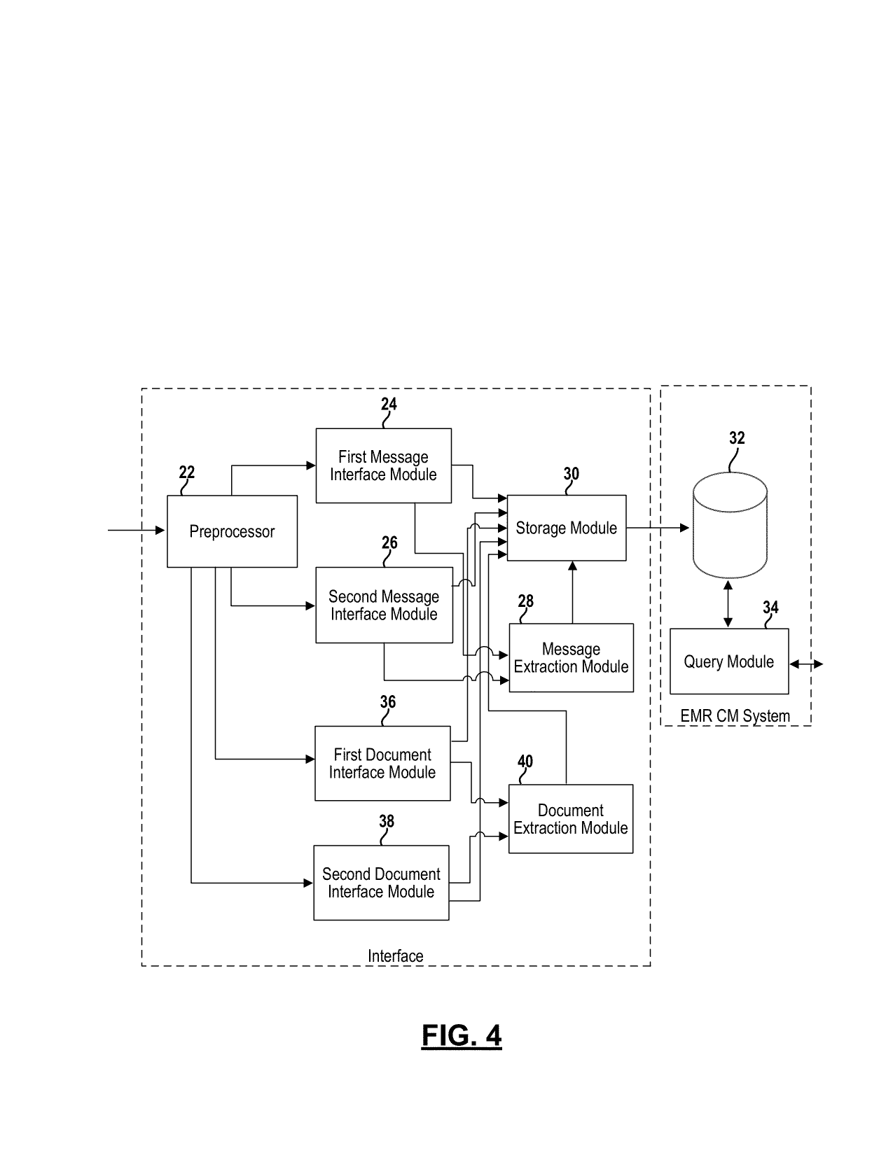

With reference to FIG. 4, a functional block diagram of an example interface is shown. The interface includes a preprocessor 22, a first message interface module 24, a second message interface module 26, a message extraction module 28, and a storage module 30. The preprocessor 22 is configured to receive messages from any of the plurality of data communications systems, for example the EMR system 14 as described FIG. 1. The messages may be formatted according to HL7 observation result message standards (ORU message). The ORU messages include patient data regarding ordered tests and test results.

The ORU message includes a plurality of segments, including, but not limited to, the observation request (OBR) segment, the observations (OBX) segment, and the notes and comments (NTE-2) segment. The OBR is used as a report header, and includes important information about an order being fulfilled (i.e., order number, request date/time, observation date/time, ordering provider, etc.). The OBR is part of a group that can be used more than once for each observation result that is reported in the ORU message. The OBR segment also includes information related to the subject matter of the ORU message. For example, the header section of the OBR segment includes text indicating whether the ORU message pertains to patient blood glucose data. The header may also include a blood glucose measurement. The OBX segment includes actual clinical observation results as a single observation or observation fragment. The NTE-2 segment is a free-form text field that includes comments, notes, and other information entered by an originator of the message. The text included in the NTE-2 segment may also be formatted in accordance with a structured test data schema.

The structured test data schema includes a plurality of structured test data fields. The plurality of structured test data fields include a test type field, a data format identification field, a data specific field (or fields), and a note field. The test type field includes information that indicates the type of structured test a given message relates to. For example, the structured test types include, but are not limited to, testing in pairs and a three-day profile test. The data format identification field is indicative of the measurement type included in the given message. For example, measurement types may include, but are not limited to, a single measurement, a complete structured test, and a structured test report. When the measurement is a single measurement, the test type field may also include a unique identifier specifying that the current measurement is one of several total measurements. For example, the unique identifier may be “test1of2” or “test2of3”. The data specific field includes test specific data, such as a measurement event and a glucose measurement. In another example, the header of the message may also include a blood glucose measurement. The blood glucose measurement may also be duplicated in the comment field. The measurement event may be before exercise, after exercise, before eating, or after eating, for example. An example of a single measurement comment formatted according to the structured test data schema is given below:

<test type>\ testing in pairs - test1of2\<data format
ID>\single measurement \<data specific>\before breakfast:80\<note>\\

In the above example, the measurement type is a single measurement, the structured test type is the first of two testing in pairs measurements, the event is before breakfast, and the glucose value is 80 milligrams per deciliter (mg/dL). Another example of a comment formatted to follow the structured test data schema may include data correlating to a complete structured test. For example:

<test type>\testing in pairs\<data format ID>\complete
structured test\<data specific>\before breakfast:80\after
breakfast:150\<note>\test completed Monday December 17, 2012\

In the above example, the measurement type is a complete structured test, the structured test type is testing in pairs, the event is before and after breakfast, the glucose value before breakfast is 80 mg/dL, the glucose value after breakfast is 150 mg/dL, and the notes field indicates the day and date the test was captured.

In yet another example, a plurality of comments formatted follow the structured test data schema may be correlated into a structured test report. A structured test report includes multiple messages pertaining to the same patient. The message may be generated at different times, and therefore may be sent separately from other message pertaining to the same report. The messages may be correlated to assemble the structured test report. For example:

```
Timestamp: March 16, 2013 14:24
Blood Glucose Value: 120 mg/dL
Comment Field:
    <ST_TYPE>Testing In Pairs</ST_TYPE>
    <Data Format ID>Report</Data Format ID>
    <TIPQuestion>How Walking Affects Blood Glucose</TIPQuestion>
    <Row>1</Row>
    <Column>BEFORE</Column>
    <Note></Note>
    <Event>COMPLETE</Event>
Timestamp: March 16, 2013 14:58
Blood Glucose Value: 200 mg/dL
Comment Field
    <ST_TYPE>Testing In Pairs</ST_TYPE>
    <Data Format ID>Report</Data Format ID>
    <Row>1</Row>
    <Column>AFTER</Column>
    <Note> No walking </Note>
    <Event>COMPLETE</Event>
Timestamp: March 17, 2013 14:06
Blood Glucose Value: 125 mg/dL
Comment Field
    <ST_TYPE>Testing In Pairs</ST_TYPE>
    <Data Format ID>Report</Data Format ID>
    <Row>2</Row>
    <Column>BEFORE</Column>
    <Note></Note>
    <Event>COMPLETE</Event>
Timestamp: March 17, 2013 14:41
Blood Glucose Value: 165 mg/dL
Comment Field
    <ST_TYPE>Testing In Pairs</ST_TYPE>
    <Data Format ID>Report</Data Format ID>
    <Row>2</Row>
    <Column>AFTER</Column>
    <Note>Walked 30 minutes after lunch</Note>
    <Event>COMPLETE</Event>
```

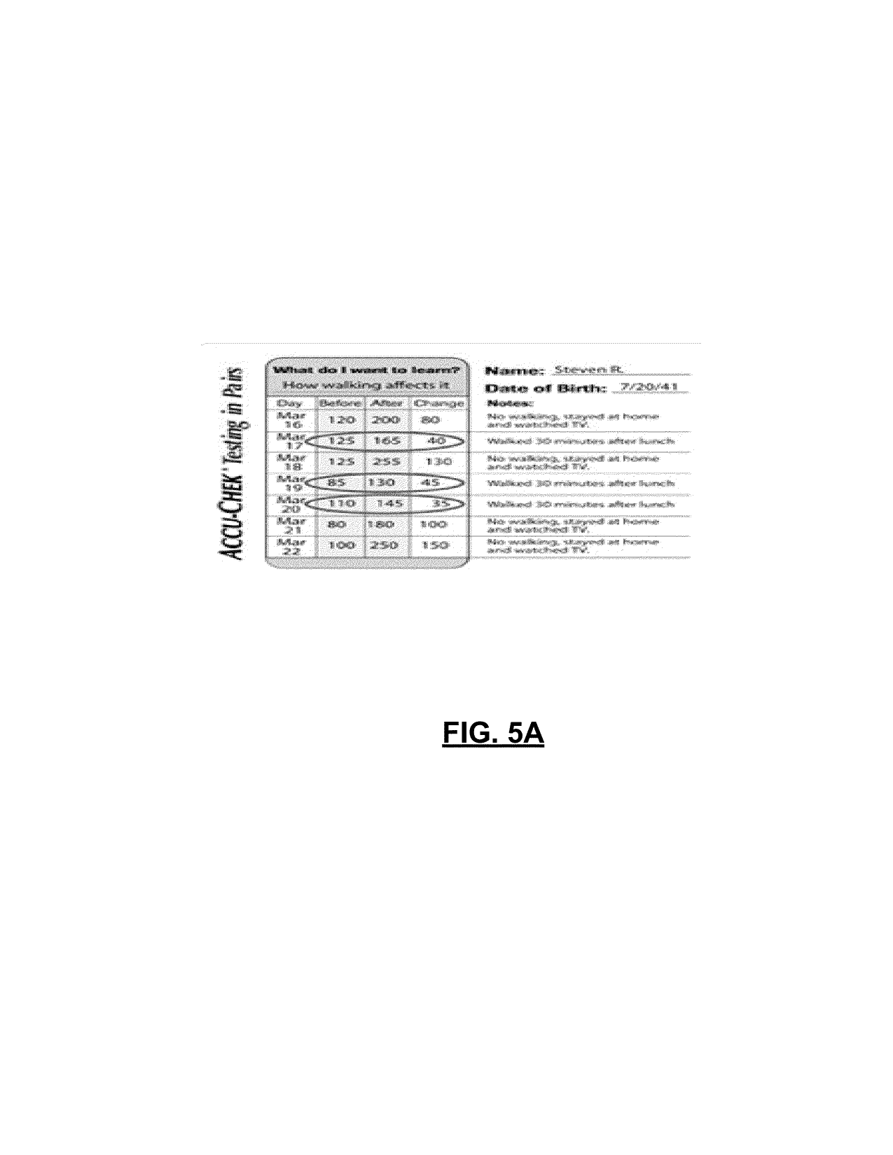

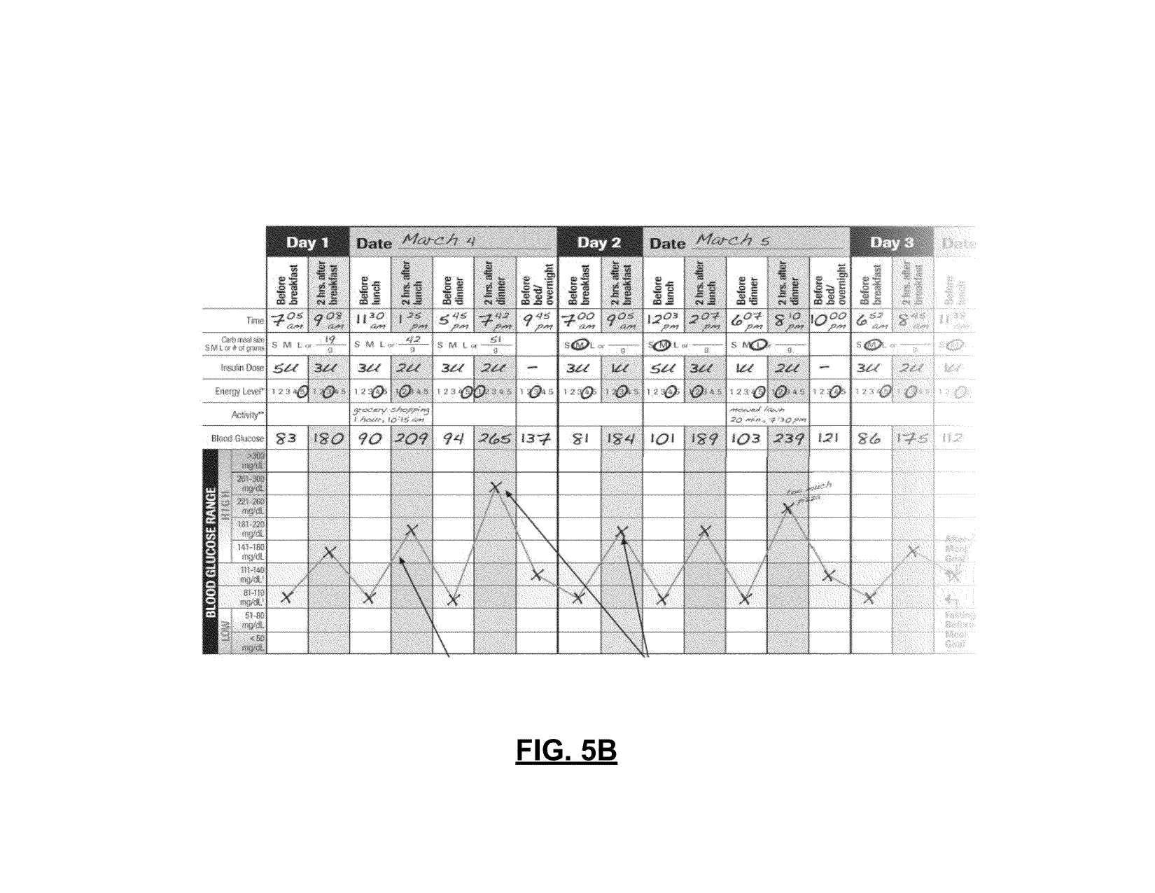

In the above report example, the measurement type is a structured test report and the structured test type is testing in pairs. A structured test report may also include data regarding the type of event being monitored by the data. In this example, the report is tracking data relating to how walking affects blood glucose. Each message included in a structured test report includes a blood glucose value. The structure test report data may be used to generate a graphical representation of the patient's structured test measurements. An example testing in pairs structured test report is shown at FIG. 5A.

Another example of a structured test report corresponding to a three-day profile test is as follows:

```
Timestamp: March 4, 2013 7:05
Blood Glucose Value: 83 mg/dL
Comment Field
    <ST_TYPE>3 Day Profile</ST_TYPE>
    <Data Format ID>Report</Data Format ID>
    <Day>1</Day>
    <Column>BEFORE BREAKFAST</Column>
    <Meal Size>19 gram</Meal Size>
    <Energy Level>5</Energy Level>
    <Activity></Activity>
    <Event>COMPLETE</Event>
Timestamp: March 5, 2013 7:00
Blood Glucose Value: 81 mg/dL
Comment Field
    <ST_TYPE>3 Day Profile</ST_TYPE>
    <Data Format ID>Report</Data Format ID>
    <Day>2</Day>
    <Column>BEFORE BREAKFAST</Column>
    <Meal Size>MEDIUM</Meal Size>
    <Energy Level>4</Energy Level>
    <Activity></Activity>
    <Event>COMPLETE</Event>
Timestamp: March 6, 2013 6:52
Blood Glucose Value: 86 mg/dL
Comment Field
    <ST_TYPE>3 Day Profile</ST_TYPE>
    <Data Format ID>Report</Data Format ID>
    <Day>3</Day>
    <Column>BEFORE BREAKFAST</Column>
    <Meal Size>MEDIUM</Meal Size>
    <Energy Level>5</Energy Level>
    <Activity></Activity>
    <Event>COMPLETE</Event>
```

In the above report example, the measurement type is a structured test report and the structured test type is a three-day profile test. A structured test report may also include data regarding the type of event being monitored by the data. In this example, the report is tracking data relating to how blood glucose fluctuates throughout the day, and specifically before and after meals. Each message included in a structured test report includes a blood glucose value. The structure test report data may be used to generate a graphical representation of the patient's structured test measurements. While only 3 samples are shown in the example above, it is understood that a three-day profile test may include multiple measurements for each of the three days. An example three-day structured test report is shown at FIG. 5B.

Messages may be transmitted by the EMR system 14 in accordance with a particular healthcare interoperability standard according to a particular data format. For example, messages may be transmitted according to the Continua standard as well as the Healthcare Information Technology Standards Panel (HITSP) standard. While reference is made to these two particular standards it is understood that the messages may be transmitted in accordance with other healthcare interoperability standards according to other data formats.

The preprocessor 22 is further configured to authenticate a username and password associated with the transmitted messages as previously described in detail in FIG. 1. After the preprocessor 22 has authenticated the transmitted messages, the preprocessor 22 determines the particular healthcare interoperability standard associated with each of the transmitted messages. The preprocessor 22 then determines whether to communicate the transmitted messages to the first message interface module 24 or the second message interface module 26 based on a configuration of the first message interface module 24 and the second interface module 26.

For example, the first message interface module 24 is configured to receive messages transmitted in accordance with the Continua standard and the second message interface module 26 is configured to receive messages transmitted in accordance with the HITSP standard. When the preprocessor 22 determines a transmitted message is formatted in accordance with the Continua standard, the preprocessor 22 communicates the message to the first message interface module 24. Similarly, when the preprocessor 22 determines a transmitted message is formatted in accordance with the HITSP standard, the preprocessor 22 communicates the transmitted message to the second message interface module 26.

Upon receiving the transmitted messages from the preprocessor 22, the first message interface module 24 and the second message interface module 26 translate the messages from the Continua and HITSP standards into format suitable to interface with the EMR CM system 10. For example, the first message interface module 24 is configured to receive and translate messages formatted in the Continua standard. The first message interface module 24 processes data contained in data fields in the received message and correlates the data into an EMR CM data schema. The first message interface module 24 then communicates the formatted message to the storage module 30. The storage module 30 is configured to receive messages formatted in the EMR CM data schema and map the message data to corresponding data fields in a database 32.

Similarly, the second message interface module 26 is configured to receive and translate messages formatted in the HITSP standard. The second message interface module 26 processes data contained in data fields in the received message and correlates the data into an EMR CM data schema. The second message interface module 26 then communicates the formatted message to the storage module 30. The storage module 30 is configured to receive messages formatted in the EMR CM data schema and map the message data to corresponding data fields in the database 32.

In some implementations, the first message interface module 24 and the second message interface 26 communicate text included in the NTE-2 comment field included with a received message to the message extraction module 28. The first message interface module 24 and the second message interface module 26 are configured to determine whether a message includes patient blood glucose data. For example, the first message interface module 24 receives an ORU message. The first message interface module 24 is configured to interpret text included in the header of the ORU message. The first message interface module 24 determines whether the ORU message pertains to patient blood glucose data based on the text included in the header of the ORU message.

When the first message interface module 24 and second message interface module 26 determine the ORU message pertains to patient blood glucose data, the first message interface module 24 and the second interface module 26 communicate the text from the NTE-2 segment to the message extraction module 28. In another example, when the first message interface module 24 and the second message interface module 26 determine the NTE-2 segment includes text, the first message interface module 24 and the second message interface module 26 communicate the text from the NTE-2 to the message extraction module 28. While only reference is made to communicating messages related to blood glucose measurements, the first message interface module 24 and the second message interface module 26 may receive and communicate messages related to any medical subject matter.

The text included in the NTE-2 segment is formatted according to the structured test data schema. The message extraction module 28 is configured to extract data from the text based on the structured test data schema. For example, the message extraction module 28 determines whether the measurement type is a single measurement, a complete structured test, or a structured test report.

For example, when the message extraction module 28 determines the structured test type is a three-day profile test, the message extraction module 28 determines whether the measurement corresponds to the first day, the second day, or the third day of the three-day profile test. The message extraction module 28 is configured to interpret the structured test data schema. The structured test data schema may be formatted to follow XML language standards. The message extraction module 28 reads XML tags associated with the data fields in the structured test data schema. For example, message extraction module 28 may determine the structured test type by interpreting an XML tag that indicates the structured test type.

The message extraction module 28 then communicates the event and glucose measurement corresponding to the measurement to the storage module 30. When the message extraction module 28 subsequently receives data related to the other of the first, second, or third days of the three-day profile test, the message extraction module 28 communicates events and glucose measurements corresponding to the subsequent measurements to the storage module 30. The storage module 30 is configured to correlate the measurements associated with a testing in pairs test or a three-day profile test. The message extraction module 28 formats the extracted data into a format suitable to communicate with the database 32. For example, the message extraction module 28 formats the extracted data according to the EMR CM data schema. The message extraction module 28 communicates the formatted extracted data to the storage module 30.

In general, the storage module 30 is configured to update appropriate data records in the database 32 using data encapsulated in the data received from the first message interface module 24, the second message interface module 26, and the message extraction module 30.

The interface also includes a first document interface module 36, a second document interface module 38, and a document extraction module 40. The first document interface module 36 and the second document interface module 38 are configured to receive documents directed to the EMR CM system 10 and update appropriate data record in the EMR CM system 10 using data encapsulated in the received documents. The documents may be formatted according to HL7 Clinical Document Architecture (CDA) standards. The CDA documents include a header and a body. The header may include at least patient information, author name, creation date, document type, and provider name. The header may also include information regarding the subject matter of a particular CDA document. For example, the header may include text indicating the CDA document pertains to patient blood glucose data. The body may include at least admission details, diagnosis, patient details, medications, and follow-up details. The CDA documents include a narrative block. The narrative block is human readable text and may include patient testing data. For example, the narrative block may include structured test data. The text in the narrative block is formatted according to the structure test data schema. The CDA documents are formatted using Extensible Markup Language (XML). An example of a CDA document formatted using XML is given below:

```
<ClinicalDocument>
    ... CDA Header ...
    <structuredBody>
        <section>
            <text>...</text>
            <observation>...</observation>
            <substanceAdministration>
                <supply>...</supply>
            </substanceAdministration>
            <observation>
                <externalObservation>...
                </externalObservation>
            </observation>
        </section>
        <section>
            <section>...</section>
        </section>
    </structuredBody>
</ClinicalDocument>
```

The documents may be transmitted in accordance with a particular healthcare interoperability standard and formatted according to a particular data format. In an exemplary embodiment, the first document interface module 36 is configured to receive documents transmitted in accordance with the Continua standard and the second document interface module 38 is configured to receive documents transmitted in accordance with the HITSP standard. The preprocessor 22 is configured to receive documents directed to the EMR CM system 10. The preprocessor 22 is further configured to determine the particular data format of the transmitted documents and to communicate the transmitted documents to the first document interface module 36 and the second document interface module 38. When the preprocessor 22 determines a transmitted document is formatted in accordance with the Continua standard, the preprocessor 22 communicates the document to the first document interface module 36. Similarly, when the preprocessor 22 determines a transmitted document is formatted in accordance with the HITSP standard, the preprocessor 22 communicates the transmitted document to the second document interface module 38.

Upon receiving the transmitted documents from the preprocessor 22, the first document interface module 36 and the second document interface module 38 translate the documents from the Continua and HITSP standards into a format suitable to interface with the EMR CM system 10. For example, the first document interface module 36 is configured to receive and translate documents formatted in the Continua standard. The first document interface module 36 processes data included in data fields in the received document and correlates the data into the EMR CM data schema. The first document interface module 36 then communicates the formatted document to the storage module 30. The storage module 30 is configured to receive data formatted in the EMR CM data schema and map the data to corresponding data fields in a database 32.

Similarly, the second document interface module 38 is configured to receive and translate documents formatted in the HITSP standard. The second document interface module 38 processes data included in data fields in the received documents and correlates the data into the EMR CM data schema. The second document interface module 38 then communicates the formatted data to the storage module 30. The storage module 30 is configured to receive data formatted in the EMR CM data schema and map the data to corresponding data fields in a database 32.

In some implementations, the first document interface module 36 and the second document interface 38 are configured to determine whether a received document pertains to patient blood glucose data. For example, the first document interface module 36 receives a CDA document. The first document interface module 36 is configured to interpret text included in the header of the CDA document. The first document interface module 36 determines the CDA document pertains to patient blood glucose data based on the text included in the header of the CDA document. While only documents relating to blood glucose measurements are described, it is understood that the first document interface module 36 and the second document interface module 38 may receive and communicate documents related to any medical subject matter.

When the first document interface module 36 and the second document interface module 38 determine the CDA document pertains to patient blood glucose data, the first document interface module 36 and the second document interface module 38 communicate the text from the narrative block of the CDA document to the document extraction module 40. In another example, when the first document interface module 36 and the second document interface module 38 determine the narrative block includes text, the first document interface module 36 and the second document interface module 38 communicate the text from the narrative block to the document extraction module 40. In yet another embodiment, the first document interface module 36 and the second document interface module 38 communicate the narrative block from all received documents to the document extraction module 40. In some embodiments, it is envisioned that message extraction module and the document extraction module may be combined into a single extraction module.

The text included in the narrative block is formatted according to the structured test data schema as described above. The document extraction module 40 is configured to extract data from the narrative block based on the structured test data schema. For example, the document extraction module 40 determines whether the measurement type is a single measurement, a complete structured test, or a structured test report. While only a single measurement, a complete structured test, and a structured test report are described, it is understood that any the present disclosure relates to all measurement types.

For example, when the document extraction module 40 determines the structured test type is a three-day profile test, the document extraction module 40 determines whether the measurement corresponds to the first day, the second day, or the third day of the three-day profile test. The document extraction module 40 then communicates the event and glucose measurement that correspond to the measurement to the storage module 30. When the document extraction module 40 subsequently receives data related to the other of the first, second, or third days of the three-day test, the document extraction module 40 communicates the events and glucose measurements associated with the subsequent measurements to the storage module 30.

The storage module 30 is configured to correlate the measurements associated with a testing in pairs test or a three-day test. For example, the storage module 30 may determine that a first message includes a first of two related messages based on text included in the comment field of the message. The storage module 30 maps the first message to correlating fields in the database 32. In one example, the database 32 may include a test identifier field. The storage module 30 may map a unique test identifier to the test identifier field in order to correlate messages relating to a specific structured test. The document extraction module 40 formats the extracted data into a format suitable to communicate with the database 32. For example, the document extraction module 40 formats the extracted data according to the EMR CM data schema. In some embodiments, comments included in messages and documents may be transmitted to the message extraction module 28 and/or the document extraction module 40. The message extraction module 28 may be configured to extract data from comments included in both messages and documents. Similarly, the document extraction module 40 may be configured to extract data from comments included in both messages and documents. In another embodiment, the message extraction module 28 and the document extraction module 40 may communicate with a data extraction module to extract data from comments included in messages and documents.

EMR CM system 10 may also include a query module 34. The query module 34 is configured to receive requests from the EMR system 14 for medical data stored in the database 32. Each request is specific to a patient. Requests are transmitted and responded to in accordance with a particular healthcare interoperability standard. In an exemplary implementation, the query module 34 supports requests according to the Continua and HITSP standards although support for other standards are also contemplated by this disclosure. The requested data may be used to view a patient's history corresponding to a patient's structured test data

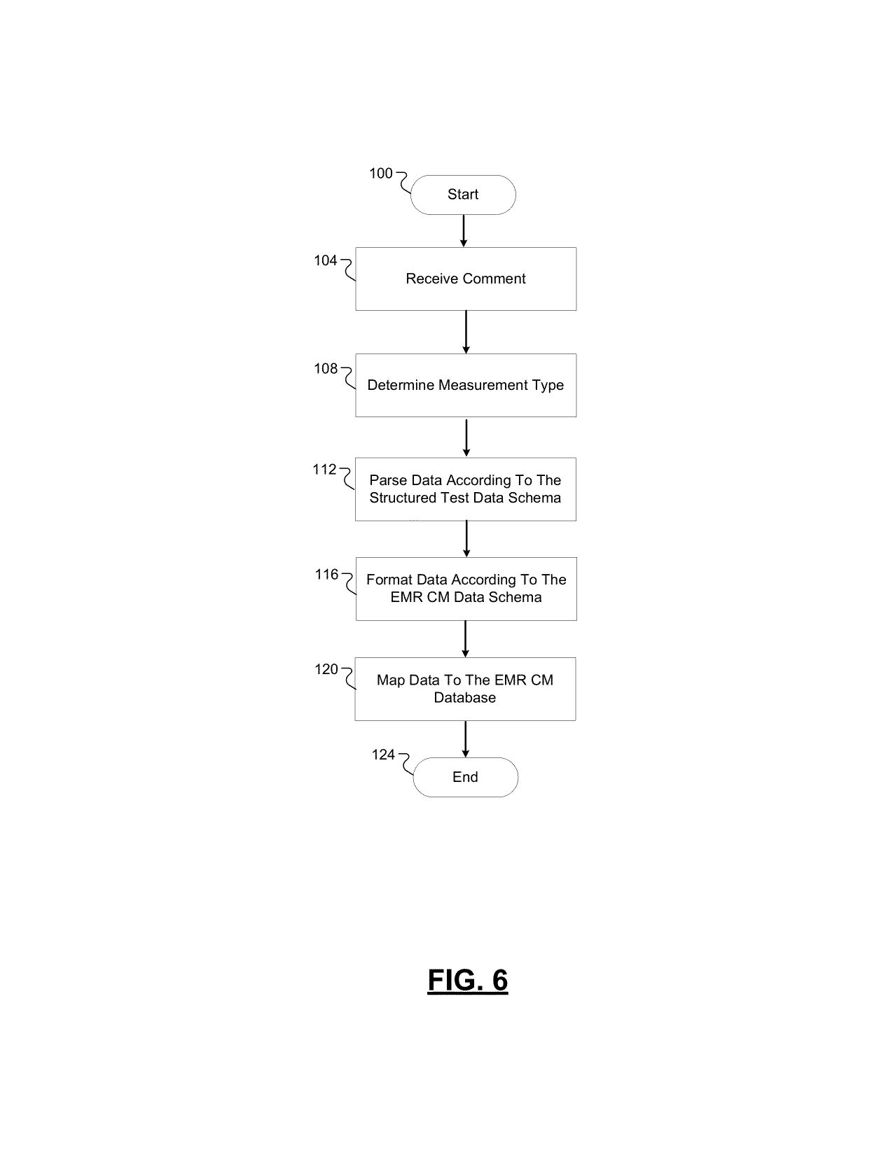

FIG. 6 depicts an exemplary implementation for the message extraction module. An exemplary data extraction method 100 begins at 104. At 104, the method 100 receives a comment associated with a blood glucose test measurement. At 108, the method 100 determines the measurement type associated with the blood glucose test measurement, for example, a single measurement, a complete structured test, or a structured test report. At 112, the method 100 parses data according to the structured test data schema. The method 100 is configured to interpret data formatted according to the structured test data schema. In one embodiment, the structured test data schema is formatted to include XML tags indicative of the type of measurement, the type of test, an event and blood glucose measurement. The method 100 interprets the data following the XML tags. At 116, the method 100 formats the extracted data according to the EMR CM data schema. The EMR CM data schema is formatted to communicate with the EMR CM Database. At 120, the method 100 maps the extracted data in correlating data fields within the EMR CM database. It is to be understood that only the relevant steps are discussed in relation to FIG. 6 but that other software-implemented instructions may be needed to implement a data extraction module.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program or computer modules stored on a computer-readable medium that can be accessed by the computer. Such a computer program or computer modules may be stored in a tangible computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An interface for an electronic medical record (EMR) system, comprising:
a first message interface module configured to receive messages having a message data format and transmitted to the EMR system in accordance with a first device healthcare interoperability standard and determine whether a given message pertains to blood glucose measures, wherein the first message interface module is operable to generate records in a custom format of the EMR system;
a second message interface module configured to receive messages having the message data format but transmitted to the EMR system in accordance with a second device healthcare interoperability standard and determine whether a given message pertains to blood glucose measures, wherein the second message interface module is operable to generate records in the custom format of the EMR system;
a message extraction module interoperable with the first and second message interface module to parse the received messages, the message extraction module extracts data for a structure collection procedure from a comment field of the given message and maps the structured collection procedure data to applicable data fields in a corresponding record of the EMR system, where the structured collection procedure specifies one or more collection events for obtaining blood glucose measures from a patient;
a first document interface module configured to receive documents having a document data format and transmitted to the EMR system in accordance with the first device healthcare interoperability standard and determine whether a given document pertains to blood glucose measures, wherein the first document interface module is operable to generate records in the custom format of the EMR system;
a second document interface module configured to receive documents having the document data format but transmitted to the EMR system in accordance with the second device healthcare interoperability standard and determine whether a given document pertains to blood glucose measures, wherein the second document interface module is operable to generate records in the custom format of the EMR system;
a document extraction module interoperable with the first and second document interface module to parse the received documents, the document extraction module extracts data for a structure collection procedure from a narrative block of the given document and maps the structured collection procedure data to applicable data fields in a corresponding record of the EMR system;
wherein the interface is implemented as code executed by a processor.

2. The interface of claim 1 wherein the message extraction module extracts data from comment field using a structured test data schema, where the structured test data scheme includes an identifier for the type of structured test to which the comment field pertains and an identifier for format of data contained in the comment field.

3. The interface of claim 1 further comprising a preprocessor module configured to receive a given message and route the given message to the first message interface module when the given message was transmitted in accordance with the first device healthcare interoperability standard and route the given message to the second message interface module when the given message was transmitted in accordance with the second device healthcare interoperability standard.

4. The interface of claim 1 further comprising a storage module configured to receive the generated records from the first message interface module, the second message interface module, the first document interface module and the second document interface module and update a database using data in the generated records.

5. The interface of claim 1 wherein the message data format is further defined as the ORU-R01 message format of the Health Level Seven (HL7) standard.

6. The interface of claim 1 wherein the document data format is further defined as the Clinical Document Architecture (CDA) of the Health Level Seven (HL7) standard.

7. The interface of claim 1 wherein the first device healthcare interoperability standard is further defined in accordance with Continua Personal Health Data Standards and the second device healthcare interoperability standard is further defined in accordance with the Health Information Technology Standard Panel (HITSP).

8. The interface of claim 1 wherein a structured collection procedure of a first type specifies a pair of collection events that fall within a window of time which encapsulate a given event, where a first collection event in the pair of collection events occurs before the given event and a second collection event in the pair of collection events occurs after the given event.

9. The interface of claim 1 wherein a structured collection procedure of a second type specifies a plurality of predefined time slots for obtaining blood glucose measures throughout the course of a given day.

10. An interface for an electronic medical record (EMR) system, comprising:
a first message interface module configured to receive messages having a message data format and transmitted to the EMR system in accordance with a first device healthcare interoperability standard and determine whether a given message pertains to blood glucose measures, wherein the first message interface module is operable to generate records in a custom format of the EMR system;
a second message interface module configured to receive messages having the message data format but transmitted to the EMR system in accordance with a second device healthcare interoperability standard and determine whether a given message pertains to blood glucose measures, wherein the second message interface module is operable to generate records in the custom format of the EMR system;
a message extraction module interoperable with the first and second message interface module to parse the received messages, the message extraction module extracts data for a structure collection procedure from a comment field of the given message and maps the structured collection procedure data to applicable data fields in a corresponding record of the EMR system, where the structured collection procedure specifies one or more collection events for obtaining blood glucose measures from a patient;

11. The interface of claim 10 wherein the message extraction module extracts data from comment field using a structured test data schema, where the structured test data scheme includes an identifier for the type of structured test to which the comment field pertains and an identifier for format of data contained in the comment field.

12. The interface of claim 10 further comprising a preprocessor module configured to receive a given message and route the given message to the first message interface module when the given message was transmitted in accordance with the first device healthcare interoperability standard and route the given message to the second message interface module when the given message was transmitted in accordance with the second device healthcare interoperability standard.

13. The interface of claim 10 further comprising a storage module configured to receive the generated records from the first message interface module, the second message interface module, the first document interface module and the second document interface module and update a database using data in the generated records.

14. The interface of claim 10 wherein the message data format is further defined as the ORU-R01 message format of the Health Level Seven (HL7) standard.

15. The interface of claim 10 wherein the first device healthcare interoperability standard is further defined in accordance with Continua Personal Health Data Standards and the second device healthcare interoperability standard is further defined in accordance with the Health Information Technology Standard Panel (HITSP).

16. An interface for an electronic medical record (EMR) system, comprising:
a first document interface module configured to receive documents having a document data format and transmitted to the EMR system in accordance with the first device healthcare interoperability standard and determine whether a given document pertains to blood glucose measures, wherein the first document interface module is operable to generate records in a custom format of the EMR system;
a second document interface module configured to receive documents having the document data format but transmitted to the EMR system in accordance with the second device healthcare interoperability standard and determine whether a given document pertains to blood glucose measures, wherein the second document interface module is operable to generate records in the custom format of the EMR system;
a document extraction module interoperable with the first and second document interface module to parse the received documents, the document extraction module extracts data for a structure collection procedure from a narrative block of the given document and maps the structured collection procedure data to applicable data fields in a corresponding record of the EMR system, where the structured collection procedure specifies one or more collection events for obtaining blood glucose measures from a patient.

17. The interface of claim 16 wherein the document extraction module extracts data from narrative block using a structured test data schema, where the structured test data scheme includes an identifier for the type of structured test to which the narrative block pertains and an identifier for format of data contained in the narrative block.

18. The interface of claim 16 further comprising a preprocessor module configured to receive a given document and route the given document to the first document interface module when the document message was transmitted in accordance with the first device healthcare interoperability standard and route the given document to the second document interface module when the given message was transmitted in accordance with the second device healthcare interoperability standard.

19. The interface of claim 16 further comprising a storage module configured to receive the generated records from the first message interface module, the second message interface module, the first document interface module and the second document interface module and update a database using data in the generated records.

20. The interface of claim 16 wherein the document data format is further defined as the Clinical Document Architecture (CDA) of the Health Level Seven (HL7) standard.

21. The interface of claim 16 wherein the first device healthcare interoperability standard is further defined in accordance with Continua Personal Health Data Standards and the second device healthcare interoperability standard is further defined in accordance with the Health Information Technology Standard Panel (HITSP).
